(19) United States
(12) Patent Application Publication
(10) Pub. No.: US 2008/0179335 A1
(43) Pub. Date: Jul. 31, 2008

(54) Multi-functional thermos mug having bamboo charcoal

(76) Inventors: Chang-Cheng Lee, Sioushuei (TW); Shun-Yi Cheng, Ta-li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/657,626

(22) Filed: Jan. 25, 2007

(51) Int. Cl. A47J 41/00

(52) U.S. Cl. 220/592.17

(57) ABSTRACT

The present invention is a multi-functional thermos mug having bamboo charcoal. The thermos mug comprises a lid provided therein with an inner thermos cover made from bamboo charcoal ceramics and a cup shell provided therein with an inner thermos cup body made from bamboo charcoal ceramics. The inner thermos cover and inner thermos cup body could deodorize foul smell and emit far infrared. The inner thermos cover body and the inner thermos cup body are manufactured from injection molding a powder and another plastic powder. The powder is obtained from burning a bamboo charcoal or far infrared mineral together with an anion mineral. Positioning means are provided between the components of the thermos mug such that the lid, inner thermos cover body, outer cup shell, inner thermos cup body and base cannot rotate with respect to each other or slip up and down when they are combined together. Consequently, the assembled thermos mug is multi-functional and with a great stability.

### BACKGROUND OF THE INVENTION

1. Field of the Invention

The present invent relates to a multi-functional thermos mug having bamboo charcoal. In particular, the present invention relates to the technical field of thermos receptacle for holding a liquid and the like.

2. Description of Related Art

A thermos mug known in the prior art is shown in FIG. 9. The known thermos mug is composed of an outer cup 60, an inner cup 70 and a top lid 80. The inner cup 70 is inserted and fitted in the outer cup 60. The top lid 80 covers and closes the top of the inner cup 70 and the outer cup 60. Such thermos mug inherently functions to hold a liquid and the like. However, the thermos mug involves the following problems:

Insufficient function: the thermos mug simply functions to hold liquid without other functions. Therefore, the known thermos mug cannot fulfill people's need.

Bad stability: the inner cup and the outer cup are engaged together to form an assembled thermos mug. The inner cup and outer cup are not firmly engaged. Consequently, the engaged inner cup and outer could still rotate with respect to each other.

### SUMMARY OF THE INVENTION

In view of the foregoing problems, the multi-functional thermos mug having bamboo charcoal in accordance with the present invention is developed to solve the problems of insufficient function and bad stability of the prior art thermos mug.

A primary objective of the invention is to provide a multi-functional thermos cup having bamboo charcoal. The multi-functional thermos cup is composed of a top lid, an outer cup shell and a base. The lid is provided with an inner thermos cover body made from bamboo charcoal ceramics. The outer cup shell is provided with an inner thermos cup body made from bamboo charcoal ceramics. The inner thermos cover body and the inner thermos cup body function to deodorize foul smell and emit far infrared. The inner thermos cover body and the inner thermos cup body are manufactured from injection molding a powder and another plastic powder. The powder is obtained from burning a bamboo charcoal or far infrared mineral together with an anion mineral. The lid and inner thermos cover body are respectively provided with positioning protrusions and positioning indentations. The outer cup shell and inner thermos cup shell are respectively provided with positioning rings and ring-like positioning grooves. The bottom of the cup shell and the base are respectively provided with ring-like grooves and ring-like positioning ribs such that the lid, inner thermos cover body, outer cup shell, inner thermos cup body and base cannot rotate with respect to each other or slip up and down when they are combined together. Consequently, the assembled thermos mug is multi-functional and with a great stability.

### BRIEF DESCRIPTION OF THE DRAWINGS

FIG. 1 is a perspective view schematically showing the assembled thermos mug in accordance with the present invention;

FIG. 2 is an exploded perspective view schematically showing the thermos mug in accordance with the present invention;

FIG. 3 is a sectional view showing the thermos mug in accordance with the present invention;

FIG. 4 is an exploded perspective view schematically showing a first embodiment of the present invention;

FIG. 5 is a sectional view schematically showing the first embodiment of the present invention;

FIG. 6 is an exploded perspective view schematically showing a second embodiment of the present invention;

FIG. 7 is a sectional view schematically showing a second embodiment of the present invention;

FIG. 8 is an exploded perspective view schematically showing a third embodiment of the present invention; and

FIG. 9 is a perspective view showing a thermos mug known in the art.

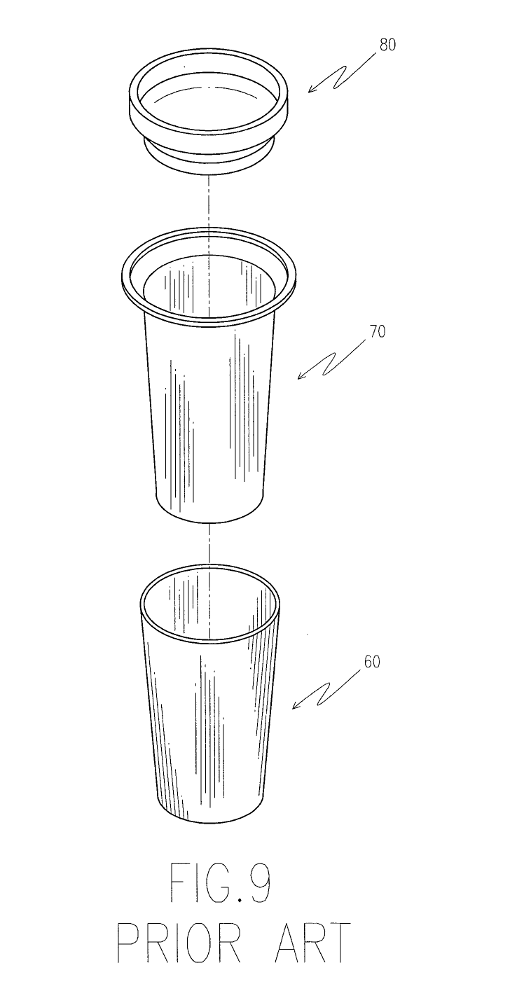

### DETAILED DESCRIPTION OF PREFERRED EMBODIMENT

To further elucidate the configurations and features of the present application, some embodiments in accordance with the present invention will be shown and described. Accordingly, the embodiments in the drawings and description are used to only illustrate, but not restrict, the present invention.

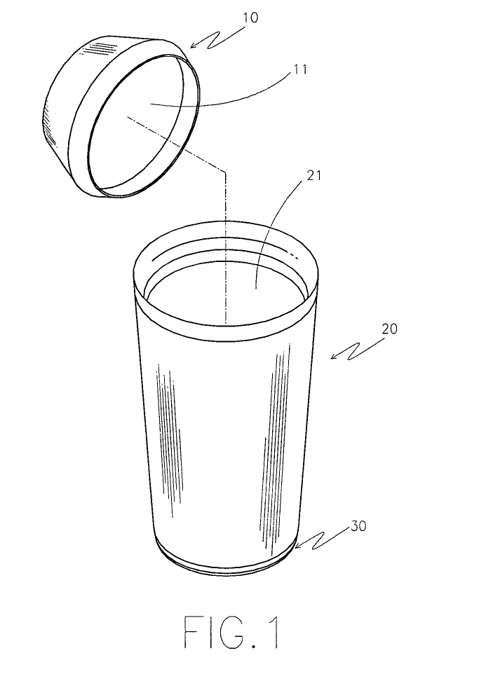

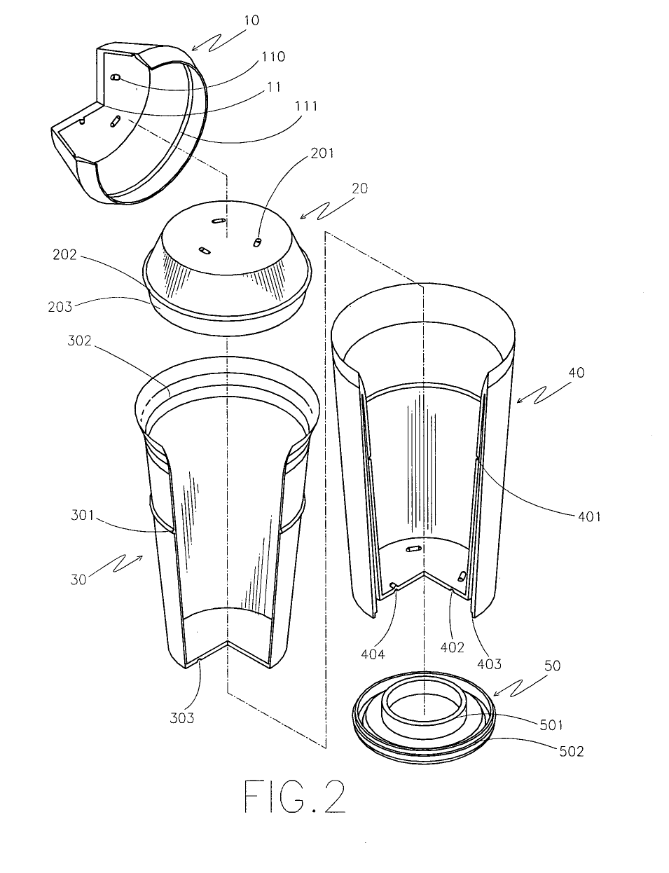

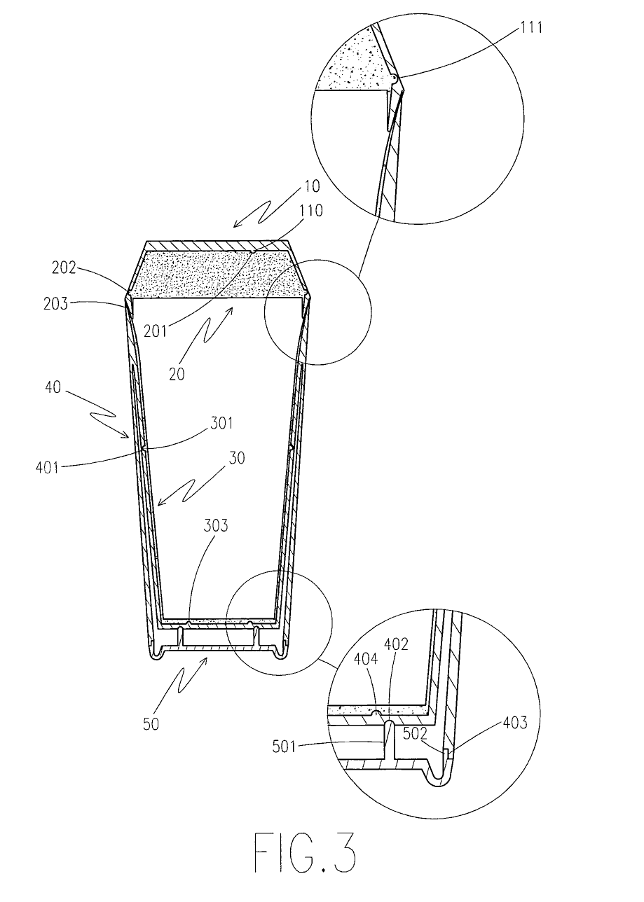

FIGS. 1 to 3 are perspective, exploded perspective and sectional views schematically showing the multi-functional thermos mug having bamboo charcoal in accordance with the present invention.

The thermos mug comprising:

a lid (10) provided with a receiving chamber (11), the receiving chamber (11) having positioning protrusions (110) and a locking groove (111);

an inner thermos cover body (20) made from bamboo charcoal ceramics, the inner thermos cover body (20) having positioning indentations (201), a locking ring (202) and a locking portion (203), the positioning indentations (201) being locked by the positioning protrusions (110) of the lid (10), and the locking ring (202) being locked in the locking groove (111) of the lid (10) when the inner thermos cover body (20) is received in the receiving chamber (11) of the lid (10);

an inner thermos cup body (30) made from bamboo charcoal ceramics, the inner thermos cup body (30) having a positioning ring groove (301), an engaging portion (302) and a lower positioning groove (303), the engaging portion (302) engaging the locking portion (203) of the inner thermos cover body (20) when the lid (10) with the inner thermos cover body (20) mounted therein covers the top of the inner thermos cup body (30);

an outer cup shell (40) provided with an annular positioning groove (401), a ring groove (402), a first locking portion (403) and lower positioning protrusions (404), the positioning ring groove (301) being locked with the annular positioning groove (401) of the outer cup shell (40), and the lower positioning groove (303) on the bottom of the inner thermos cup body (30) being locked with the lower positioning protrusions (404) of the outer cup shell (40) when the inner thermos cup body (30) is inserted into the outer cup shell (40);

a bottom base (50) provided with a positioning ring rib (501) and a second locking portion (502), the positioning ring rib (501) pushing against the ring groove (402) of the outer cup shell (40), and the second engaging portion (502) and the first engaging portion (403) of the outer cup shell (40) engaging with each other when the bottom base (50) is mounted to the bottom of the outer cup shell (40);

the inner thermos cover body (20) made from bamboo charcoal ceramics and the inner thermos cup body (30) made from bamboo charcoal ceramics are manufactured from injection molding a powder and another plastic powder, the powder is obtained from burning a bamboo charcoal or far infrared mineral together with an anion mineral.

The multi-functional thermo mug having bamboo charcoal in accordance with the present application is obtained from the configuration described in the foregoing.

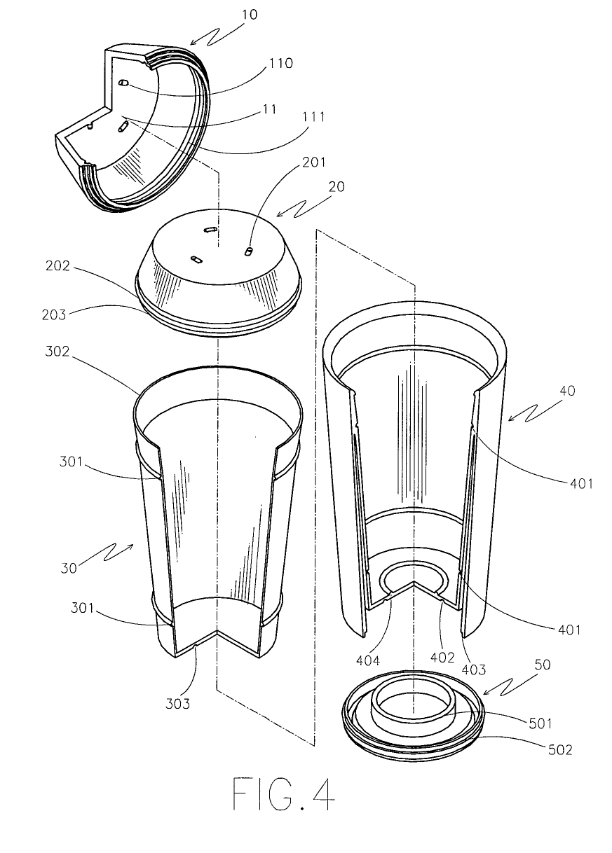

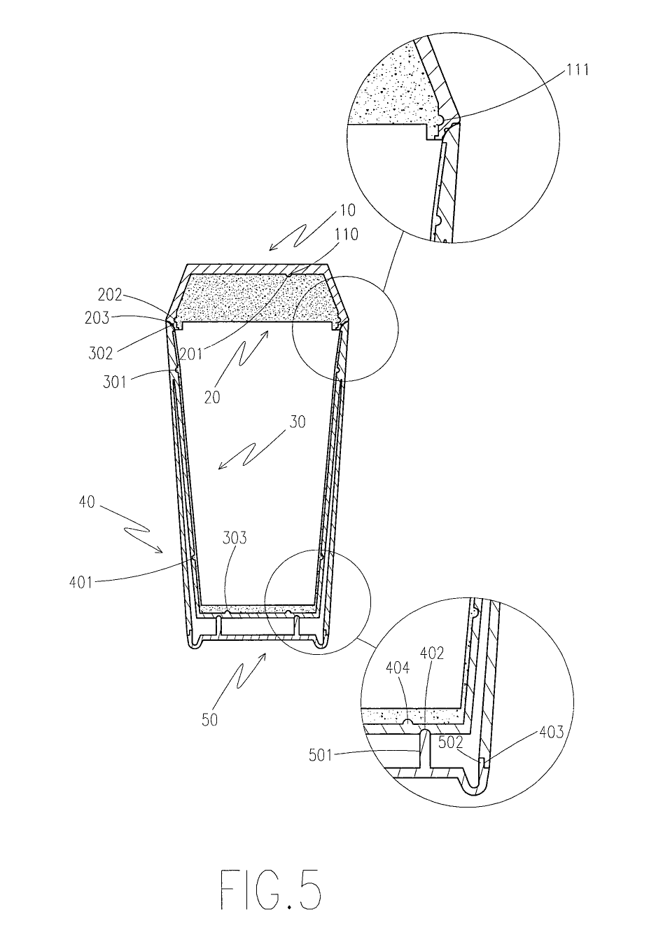

FIGS. 4 and 5 are exploded perspective view and sectional view schematically showing a first embodiment of the multi-functional thermos mug having bamboo charcoal in accordance with the present invention. Except for a few differences, the configuration of the first embodiment is generally identical to the embodiment shown in FIGS. 1 to 3. In this embodiment, the inner thermos cup body (30) made from bamboo charcoal ceramics is provided with upper and lower positioning ring grooves (301), and the outer cup shell (40) is correspondingly provided with upper and lower ring positioning grooves (401) to enhance the overall stability of the thermos mug in accordance with the invention.

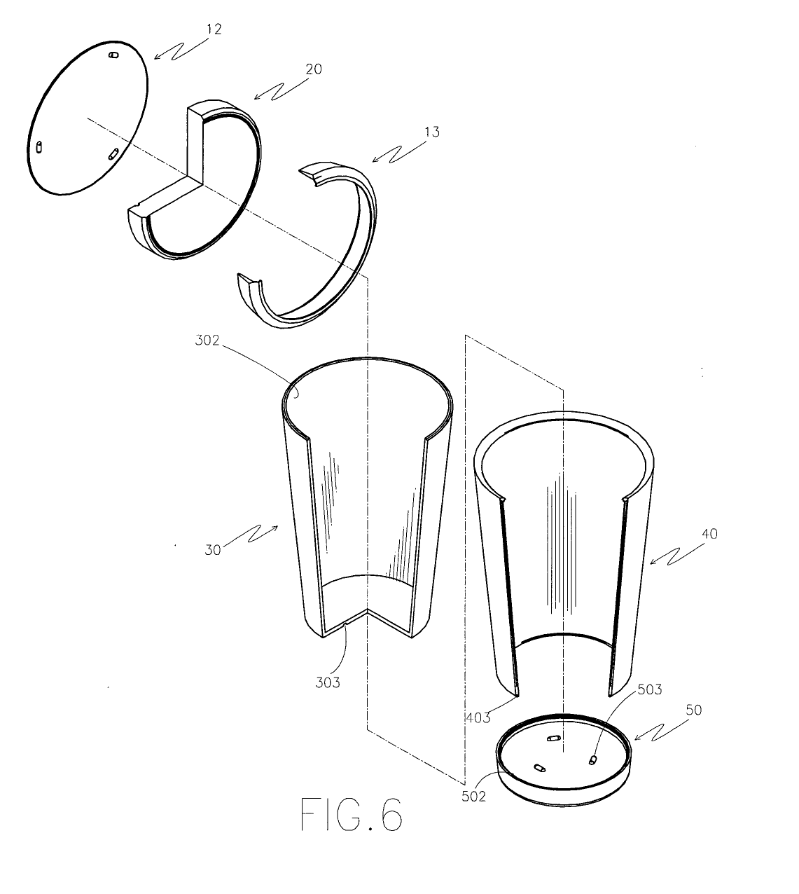

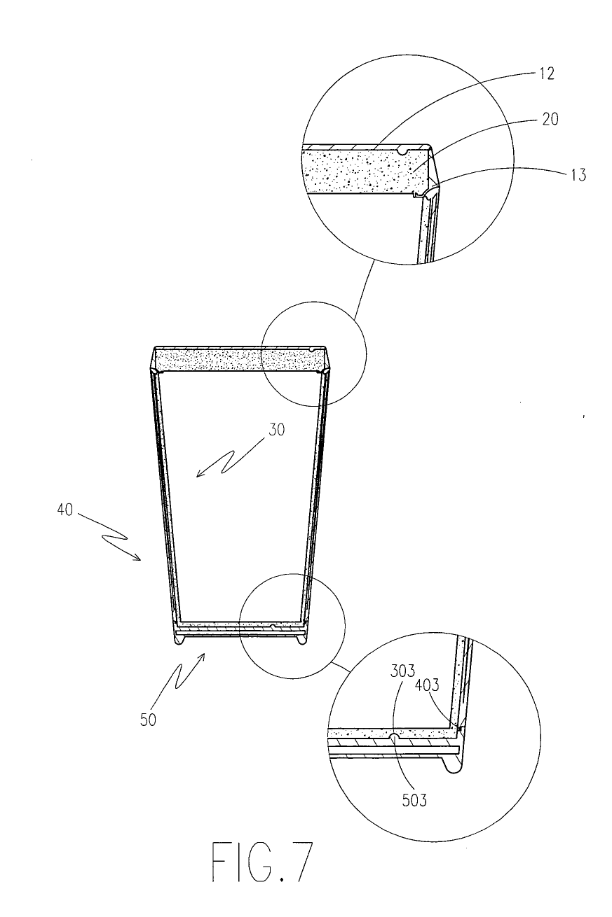

FIGS. 6 and 7 are exploded perspective view and sectional view schematically showing a second embodiment of the multi-functional thermos mug having bamboo charcoal in accordance with the present invention. In this embodiment, the lid (10) is composed of an upper cover (12) and a middle ring (13). The upper cover (12) and the middle ring (13) are combined together by means of screws, and the second locking portion (502) of the base (50) and the first locking portion (403) of the outer cup shell (40) are similarly combined by means of screws so as to enhance the functions of the present invention.

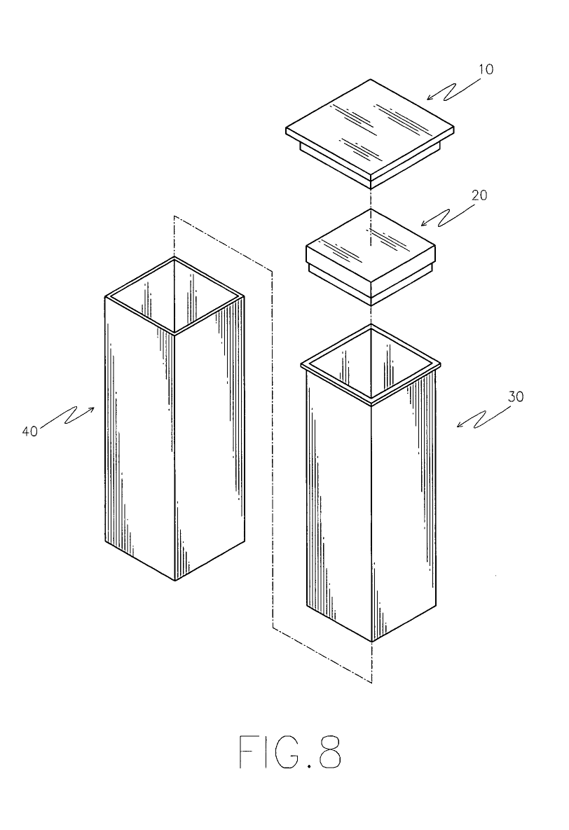

FIG. 8 is an exploded perspective view schematically showing a third embodiment of the multi-functional thermos mug having bamboo charcoal in accordance with the present invention. In this embodiment, the configuration of the thermos mug is generally rectangular, instead of cylindrical as the other embodiments. However, the thermos mug of this embodiment similarly comprises a lid (10), an inner thermos cover body (20) mounted in the lid (10), an outer cup shell (40) and an inner thermos cup body (30) mounted in the outer cup shell (40) and a base (50) mounted to the bottom of the outer cup shell (40). The thermos mug of this embodiment uses an alternative configuration, but could obtain the same effects as the other embodiments.

Accordingly, the thermos mugs in accordance with the present invention have the functions as described in the foregoing.

What is claimed is:

1. A multi-functional thermos mug having bamboo charcoal, comprising:
a lid, an inner thermos cover body made from bamboo charcoal is integrally injection molded in the lid;
an outer cup shell, an inner thermos cup body made from bamboo charcoal is integrally injection molded in the outer cup shell; and
a base mounted to the bottom of the outer cup shell.

2. A multi-functional thermos mug having bamboo charcoal, comprising:
a lid provided with a receiving chamber, the receiving chamber having positioning protrusions and a locking groove;
an inner thermos cover body made from bamboo charcoal ceramics, the inner thermos cover body having positioning indentations, a locking ring and a locking portion, the positioning indentations being locked by the positioning protrusions of the lid, and the locking ring being locked in the locking groove of the lid when the inner thermos cover body is received in the receiving chamber of the lid;
an inner thermos cup body made from bamboo charcoal ceramics, the inner thermos cup body having a positioning ring groove, an engaging portion and a lower positioning groove, the engaging portion engaging the locking portion of the inner thermos cover body when the lid with the inner thermos cover body mounted therein covers the top of the inner thermos cup body;
an outer cup shell provided with an annular positioning groove, a ring groove, a first locking portion and lower positioning protrusions, the positioning ring groove being locked with the annular positioning groove of the outer cup shell, and the lower positioning groove on the bottom of the inner thermos cup body being locked with the lower positioning protrusions of the outer cup shell when the inner thermos cup body is inserted into the outer cup shell;
a bottom base provided with a positioning ring rib and a second locking portion, the positioning ring rib pushing against the ring groove of the outer cup shell, and the second engaging portion and the first engaging portion of the outer cup shell engaging with each other when the bottom base is mounted to the bottom of the outer cup shell;
further, the inner thermos cover body made from bamboo charcoal ceramics and the inner thermos cup body made from bamboo charcoal ceramics are manufactured from injection molding a powder and another plastic powder, the powder is obtained from burning a bamboo charcoal or far infrared mineral together with an anion mineral.

3. The multi-functional thermos mug having bamboo charcoal as claimed in claim 1, wherein:
the inner thermos cover body made from bamboo charcoal ceramics and the inner thermos cup body made from bamboo charcoal ceramics are manufactured from injection molding a powder and another plastic powder, the powder is obtained from burning a bamboo charcoal or far infrared mineral together with an anion mineral.

4. The multi-functional thermos mug having bamboo charcoal as claimed in claim 2, wherein:
the percentage of the powder obtained from burning a bamboo charcoal or far infrared mineral and anion mineral and the plastic powder is 5 wt %˜90 wt %.

5. The multi-functional thermos mug having bamboo charcoal as claimed in claim 3, wherein:
the percentage of the powder obtained from burning a bamboo charcoal or far infrared mineral and anion mineral and the plastic powder is 5 wt %˜90 wt %.
